(19) United States
(12) Patent Application Publication
(10) Pub. No.: US 2021/0064713 A1
(43) Pub. Date: Mar. 4, 2021

(54) SYSTEMS AND METHODS FOR INTERACTIVE POWER SYSTEM MODEL CALIBRATION

(71) Applicant: General Electric Company, Schenectady, NY (US)

(72) Inventors: Honggang Wang, Clifton Park, NY (US); Anup Menon, Somerville, MA (US); Jovan Z. Bebic, Clifton Park, NY (US); Radhakrishnan Srinivasan, Duval, WA (US); Manu Parashar, Seattle, WA (US)

(21) Appl. No.: 16/560,722

(22) Filed: Sep. 4, 2019

(51) Int. Cl. G06F 17/50; G06F 3/0484

(52) U.S. Cl. CPC G06F 17/5009; G06F 3/04847

(57) ABSTRACT

A system for interactive power system model calibration is provided. The system includes a computing device including at least one processor in communication with at least one memory device. The at least one processor is programmed to receive event data and model response data associated with a model to simulate, identify a plurality of tunable parameters based on the event data and the model response data, present, via a user interface, the plurality of tunable parameters to the user, receive, from the user via the user interface, one or more selections of the plurality of tunable parameters, and calibrate the model based on the one or more selections.

### STATEMENT REGARDING FEDERALLY SPONSORED RESEARCH &

DEVELOPMENT

This invention was made with government support under U.S. Government Contract Number: DE-OE0000858 awarded by the Department of Energy. The government has certain rights in the invention.

### BACKGROUND

The field of the invention relates generally to interactive power system model calibration, and more particularly, to a system for validating and calibrating power system models based on user interactions.

During 1996 Western System Coordinating Council (WSCC) blackout, the planning studies conducted using dynamic models had predicted stable system operation, whereas the real system became unstable in a few minutes with severe swings. To ensure the models represent the real system accurately, North American Electric Reliability Coordinator (NERC) requires generators above 20 MVA to be tested every 5 years or 10 years (depending on its interconnection) to check the accuracy of dynamic models and update the power plant dynamic models as necessary.

Some of the methods of performing validation and calibration on the model include performing staged tests and direct measurement of disturbances. In a staged test, a generator is first taken offline from normal operation. While the generator is offline, the testing equipment is connected to the generator and its controllers to perform a series of predesigned tests to derive the desired model parameters. This method may cost $15,000-$35,000 per generator per test in the United States and includes both the cost of performing the test and the cost of taking the generator off-line. Phasor Measurement Units (PMUs) and Digital Fault Recorders (DFRs) have seen dramatic increasing installation in recent years, which allows for non-invasive model validation by using the sub-second-resolution dynamic data. Varying types of disturbances across locations in the power system along with large installed base of PMUs makes it possible to validate the dynamic models of the generators frequently at different operating conditions.

One way to tackle the model calibration process is to use curve fitting technique. Curve fitting based on measurement data works well in many situations; however, in some regions improvements could be made. Those regions include, but are not limited to the peak area, a curve rising area, and an oscillation area. Furthermore, sometimes there are long sections of steady state data, which has little dynamic information. If not used properly, these sections will add unnecessary calculation time and burden, and they also tend to lead to a worse the final curve fitting result. In addition, there is the potential for significant deviations between simulated and measured active power, while the simulated and measured reactive power match pretty well. Accordingly, there exists a need for additional accuracy and flexibility in curve fitting for model calibration.

### BRIEF DESCRIPTION

In one aspect, a system for interactive power system model calibration is provided. A computing device includes at least one processor in communication with at least one memory device. The at least one processor is programmed to receive event data and model response data associated with a model to simulate. The at least one processor is also programmed to identify a plurality of tunable parameters based on the event data and the model response data. The at least one processor is further programmed to present, via a user interface, the plurality of tunable parameters to the user. In addition, the at least one processor is programmed to receive, from the user via the user interface, one or more selections of the plurality of tunable parameters. Moreover, the at least one processor is programmed to calibrate the model based on the one or more selections.

In another aspect, a method for interactive power system model calibration is provided. The method is implemented on a computing device including at least one processor in communication with at least one memory device. The method includes receiving event data and model response data associated with a model to simulate. The method also includes identifying a plurality of tunable parameters based on the event data and the model response data. The method further includes presenting, via a user interface, the plurality of tunable parameters to the user. In addition, the method includes receiving, from the user via the user interface, one or more selections of the plurality of tunable parameters. Moreover, the method includes presenting, to the user via the user interface, a view of an event, including a measured curve and an estimated curve. Furthermore, the method includes receiving, from the user via the user interface, a selection of a first region of the event. In addition, the method includes receiving, from the user via the user interface, a first weight associated with the first region. In addition, the method also includes performing a plurality of simulations on the model including the first weight and the one or more selections. In addition, the method further includes calibrating the model based on the plurality of simulations.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a block diagram of a power distribution grid.

FIG. 2 illustrates a high-level block diagram of a system for performing sequential calibration in accordance with some embodiments.

FIG. 3 illustrates a two-stage approach of the process for model calibration.

FIG. 4 illustrates an exemplary general framework for power system model parameter conditioning according to some embodiments.

FIG. 5A illustrates a block diagram of an exemplary system architecture for interactive power system model calibration, in accordance with one embodiment of the disclosure.

FIG. 5B illustrates an exemplary block diagram of the dynamic model relationship using the system shown in FIG. 5A.

FIGS. 6A-6F illustrate a process for identifying and estimating parameters in accordance with at least one embodiment.

FIG. 7 is an exemplary user interface for selecting a local region for calibration in accordance with at least one embodiment.

FIG. 8 is another exemplary user interface for selecting a local region for calibration in accordance with at least one embodiment.

FIG. 9 is an exemplary user interface for identifying parameters for calibration in accordance with at least one embodiment.

FIGS. 10A and 10B illustrate exemplary graphs of active and reactive power before and after calibration using the system shown in FIG. 5A.

FIG. 11 is a diagram illustrating a model calibration algorithm in accordance with some embodiments.

FIG. 12 is a diagram illustrating candidate parameter estimation algorithms in accordance with some embodiments.

FIG. 13 is a diagram illustrating an exemplary apparatus or platform according to some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments are described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Power system models are the foundation for assessing Bulk Electric System (BES) reliability, including operating limits, system stability, and power transfer planning. NERC standards related to both steady-state and dynamic model validation (e.g., MOD-026-1, MOD-027-1, MOD-033-1) require planning entities to implement a validation process to periodically compare the model to actual system behavior. The wide spread deployment of high-speed measuring devices such as PMUs, capturing systems dynamics (grid disturbance) at a higher sampling rate (e.g. 60 to 120 Hz), makes it possible to frequently compare the response of system models with dynamics observed during disturbances in the system, which is called Model Validation. The grid disturbance can also be used to correct the system model when simulated response is significantly different from the measured values, which is called Model Calibration.

A traditional simulation engine relies on differential algebraic equations (DAEs) therein to perform simulations. For example, the simulation engine may include dozens, hundreds, and the like, for a single component on the power grid. Because of the amount of different equations in the simulation engine software to represent the power system (generator, transformer, load), performance of a simulation is slow. Furthermore, the simulation engine has a non-linear response, it is not easy to automatically extract analytical gradient information which is what is needed for optimization. One simulation is the equivalent of a Jacobian Matrix Calculation which can include 200 iterations or more. Each iteration can take a minute or more. Meaning that for one simulation, the simulation engine can require at least 200 minutes of time.

Typically a dynamic simulation engine is used to facilitate both identifiability of parameters (in total) and determination of parameters for calibration. Given field data with time stamped voltage (V) and frequency (f), the simulation engine will provide the simulated active power (P′) and reactive (Q′) with the same timestamp. Parameter identification involves multiple calls of simulation engines with parameter perturbation to determine the best choice of a subset of the parameters for tuning (calibration). Calibration involves multiple calls of the simulation engine to search for the best value for the given subset of parameters determined in the identifiability step.

In the exemplary embodiment, a system for interactive power system model calibration receives event data and model response data associated with a model to simulate. The system identifies a plurality of tunable parameters based on the event data and the model response data. The system then presents the plurality of tunable parameters to the user via a user interface. The user interface receives the one or more selections of the one or more selections of the plurality of tunable parameters. The system then calibrates the model based on the one or more selections.

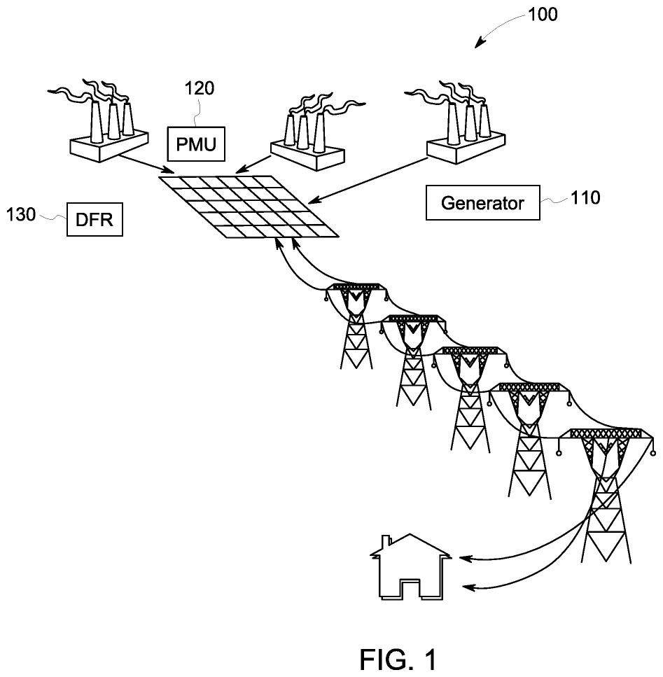

FIG. 1 illustrates a power distribution grid 100. The grid 100 includes a number of components, such as power generators 110. In some cases, planning studies conducted using dynamic models predict stable grid 100 operation, but the actual grid 100 may become unstable in a few minutes with severe swings (resulting in a massive blackout). To ensure that the models represent the real system accurately, the North American Electric Reliability Coordinator (“NERC”) requires generators 110 above 10 MVA to be tested every five years to check the accuracy of dynamic models and let the power plant dynamic models be updated as necessary. The systems described herein consider not only active power (P) and reactive power (Q) but also voltage (U) and frequency (F).

In a typical staged test, a generator 110 is first taken offline from normal operation. While the generator 110 is offline, testing equipment is connected to the generator 110 and its controllers to perform a series of pre-designed tests to derive the desired model parameters. Recently, PMUs 120 and Digital Fault Recorders (“DFRs”) 130 have seen dramatic increasing installation in recent years, which may allow for non-invasive model validation by using the sub-second-resolution dynamic data. Varying types of disturbances across locations in the grid 100 along with the large installed base of PMUs 120 may, according to some embodiments, make it possible to validate the dynamic models of the generators 110 frequently at different operating conditions. There is a need for a production-grade software tool generic enough to be applicable to wide variety of models (traditional generating plant, wind, solar, dynamic load, etc. with minimal changes to existing simulation engines. Note that model calibration is a process that seek multiple (dozens or hundreds) of model parameters, which could suffer from local minimum and multiple solutions. There is need for an algorithm to enhance the quality of a solution within a reasonable amount time and computation burdens.

Online performance monitoring of power plants using synchrophasor data or other high-resolution disturbance monitoring data acts as a recurring test to ensure that the modeled response to system events matches actual response of the power plant or generating unit. From the Generator Owner (GO)'s perspective, online verification using high resolution measurement data can provide evidence of compliance by demonstrating the validity of the model by online measurement. Therefore, it is a cost-effective approach for GO as they may not have to take the unit offline for testing of model parameters. Online performance monitoring requires that disturbance monitoring equipment such as a PMU be located at the terminals of an individual generator or Point of Interconnection (POI) of a power plant.

The disturbance recorded by PMU normally consists of four variables: voltage, frequency, active power and reactive power. To use the PMU data for model validation, the play in or playback simulation has been developed and they are now available in all major grid simulators. The simulated output including active power and reactive power will be generated and can be further compared with the measured active power and reactive power.

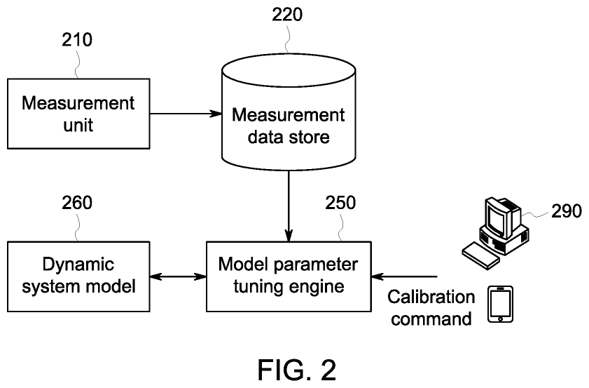

To achieve such results, FIG. 2 is a high-level block diagram of a system 200 in accordance with some embodiments. The system 200 includes one or more measurement units 210 (e.g., PMUs, DFRs, or other devices to measure frequency, voltage, current, or power phasors) that store information into a measurement data store 220. As used herein, the term “PMU” might refer to, for example, a device used to estimate the magnitude and phase angle of an electrical phasor quantity like voltage or current in an electricity grid using a common time source for synchronization. The term “DFR” might refer to, for example, an Intelligent Electronic Device (“IED”) that can be installed in a remote location, and acts as a termination point for field contacts. According to some embodiments, the measurement data might be associated with disturbance event data and/or data from deliberately performed unit tests. According to some embodiments, a model parameter tuning engine 250 may access this data and use it to tune parameters for a dynamic system model 260. The process might be performed automatically or be initiated via a calibration command from a remote operator interface device 290. As used herein, the term “automatically” may refer to, for example, actions that can be performed with little or no human intervention.

Note that power systems may be designed and operated using mathematical models (power system models) that characterize the expected behavior of power plants, grid elements, and the grid as a whole. These models support decisions about what types of equipment to invest in, where to put it, and how to use it in second-to-second, minute-to-minute, hourly, daily, and long-term operations. When a generator, load, or other element of the system does not act in the way that its model predicts, the mismatch between reality and model-based expectations can degrade reliability and efficiency. Inaccurate models have contributed to a number of major North American power outages.

The behavior of power plants and electric grids may change over time and should be checked and updated to assure that they remain accurate. Engineers use the processes of validation and calibration to make sure that a model can accurately predict the behavior of the modeled object. Validation assures that the model accurately represents the operation of the real system—including model structure, correct assumptions, and that the output matches actual events. Once the model is validated, a calibration process may be used to make minor adjustments to the model and its parameters so that the model continues to provide accurate outputs. High-speed, time-synchronized data, collected using PMUs may facilitate model validation of the dynamic response to grid events. Grid operators may use, for example, PMU data recorded during normal plant operations and grid events to validate grid and power plant models quickly and at lower cost.

The transmission operators or Regional reliability coordinators, or Independent System Operators, like MISO, ISO-New England, PG&E, can use this calibrated generator or power system model for power system stability study based on N-k contingencies, in every 5 to 10 minutes. If there is stability issue (transient stability) for some specific contingency, the power flow will be redirected to relieve the stress-limiting factors. For example, the output of some power generators will be adjusted to redirect the power flow. Alternatively, adding more capacity (more power lines) to the existing system can be used to increase the transmission capacity.

With a model that accurately reflects oscillations and their causes, the grid operator can also diagnose the causes of operating events, such as wind-driven oscillations, and identify appropriate corrective measures before those oscillations spread to harm other assets or cause a loss of load.

As used herein, devices, including those associated with the system 200 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The model parameter tuning engine 250 may store information into and/or retrieve information from various data stores, which may be locally stored or reside remote from the model parameter tuning engine 250. Although a single model parameter tuning engine 250 is shown in FIG. 2, any number of such devices may be included. Moreover, various devices described herein might be combined according to embodiments of the present invention. For example, in some embodiments, the measurement data store 220 and the model parameter tuning engine 250 might comprise a single apparatus. The system 200 functions may be performed by a constellation of networked apparatuses, such as in a distributed processing or cloud-based architecture.

A user may access the system 200 via the device 290 (e.g., a Personal Computer (“PC”), tablet, or smartphone) to view information about and/or manage operational information in accordance with any of the embodiments described herein. In some cases, an interactive graphical user interface display may let an operator or administrator define and/or adjust certain parameters (e.g., when a new electrical power grid component is calibrated) and/or provide or receive automatically generated recommendations or results from the system 200.

The example embodiments provide a predictive model which can be used to replace the dynamic simulation engine when performing the parameter identification and the parameter calibration. This is described in U.S. patent application Ser. No. 15/794,769, filed 26 Oct. 2017, the contents of which are incorporated in their entirety. The model can be trained based on historical behavior of a dynamic simulation engine thereby learning patterns between inputs and outputs of the dynamic simulation engine. The model can emulate the functionality performed by the dynamic simulation engine without having to perform numerous rounds of simulation. Instead, the model can predict (e.g., via a neural network, or the like) a subset of parameters for model calibration and also predict/estimate optimal parameter values for the subset of parameters in association with a power system model that is being calibrated. According to the examples herein, the model may be used to capture both input-output function and first derivative of a dynamic simulation engine used for model calibration. The model may be updated based on its confidence level and prediction deviation against the original simulation engine.

Here, the model may be a surrogate for a dynamic simulation engine and may be used to perform model calibration without using DAE equations. The system described herein may be a model parameter tuning engine, which is configured to receive the power system data and model calibration command, and search for the optimal model parameters using the surrogate model until the closeness between simulated response and the real response from the power system data meet a predefined threshold. In the embodiments described herein, the model operates on disturbance event data that includes one or more of device terminal real power, reactive power, voltage magnitude, and phase angle data. The model calibration may be triggered by user or by automatic model validation step. In some aspects, the model may be trained offline when there is no grid event calibration task. The model may represent a set of different models used for different kinds of events. In some embodiments, the model's input may include at least one of voltage, frequency and other model tunable parameters. The model may be a neural network model, fuzzy logic, a polynomial function, and the like. Other model tunable parameters may include a parameter affecting dynamic behavior of machine, exciter, stabilizer and governor. Also, the surrogate model's output may include active power, reactive power or both. In some cases, the optimizer may be gradient based method including Newton-like methods. For example, the optimizer may be gradient free method including pattern search, genetic algorithm, simulated annealing, particle swarm optimizer, differential evolution, and the like.

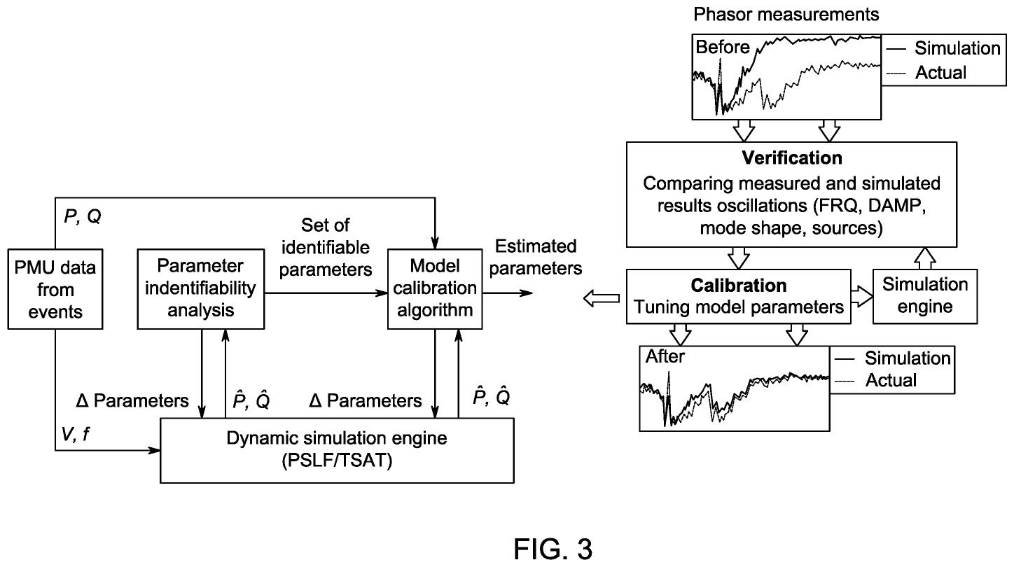

FIG. 3 illustrates a two-stage approach of the process for model calibration. In this approach, PMU data from events is fed into a dynamic simulation engine. The dynamic simulation engine communicates with a parameter identifiability analysis component and returns the changes to the parameters. The parameter identifiability analysis component also transmits a set of identifiable parameters to a model calibration algorithm component. The model calibration algorithm component uses the set of identifiable parameters, PMU data from events, and other data from the dynamic simulation engine to generate estimated parameters. This approach may be used to calibrated the tuning model parameters.

With the playback simulation capability, the user can compare the response (active power and reactive power) of system models with dynamics observed during disturbances in the system, which is called model validation. The grid disturbance can also be used to correct the system model when simulated response is significantly different from the measured values, which is called model calibration. As shown in right side of the FIG. 3, the goal is to achieve a satisfactory match between the measurement data and simulated response. If obvious discrepancy is observed, then the model calibration will be employed.

The first step of the model calibration is parameter identification, which aims to identify a subset of parameters with strong sensitivity to the observed event. Given the list of parameters ranked by their tunability, users will have a choice to choose only the subset of parameters to calibrate. Users will also be able to specify a tunable range between a min and max value. The second step is to tune the identified parameter subset using parameter estimation method. The nonlinear optimization algorithm together with the unscented Kalman filter algorithm has been both developed for parameter estimation of power system dynamic models. Based on evaluation against synthetic event data provided by NERC-/NASPI and field event data, the nonlinear least square optimization approach may be down-selected for use.

In the exemplary embodiment, the model calibration process requires a balance on matching in measurement space and reasonableness in the model parameter space. Numerical curve fitting without adequate engineering guidance tends to provide overfitted parameter result, and non-unique set of parameters (leading to same curve fitting performance), which should be avoided. The reasonableness of the tuned parameters, parameter consistency at different disturbance, and even the resulting tuned system model's stability performance at different operating condition will be evaluated during the post evaluation step.

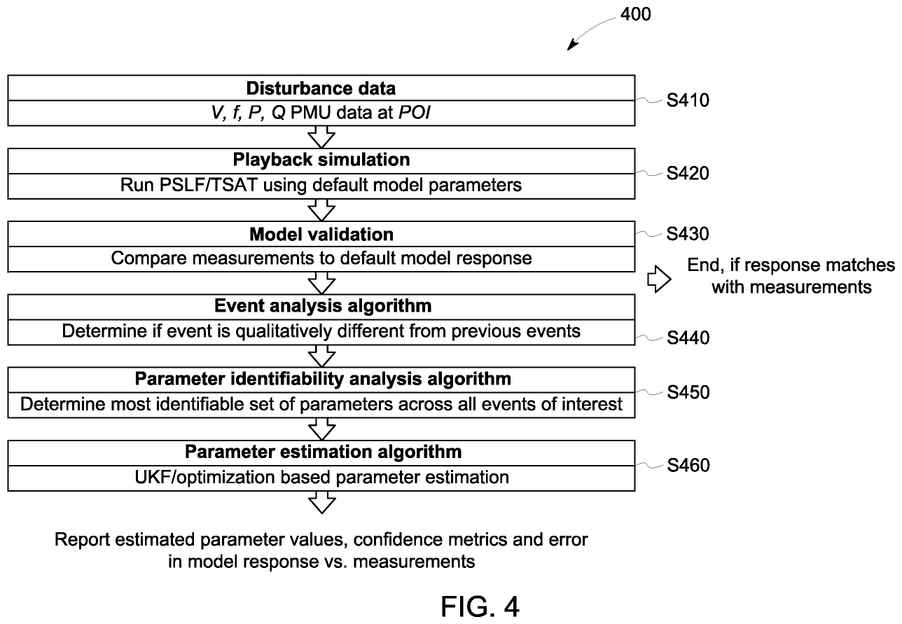

FIG. 4 illustrates an exemplary general framework 400 for power system model parameter conditioning according to some embodiments.

At S410, disturbance data may be obtained (e.g., from a PMU or DFR) to obtain, for example, V, f, P, and Q measurement data at a Point Of Interest (“POI”). At S420, a playback simulation may run load model benchmarking using default model parameters (e.g., associated with a Positive Sequence Load Flow (“PSLF”) or Transient Security Assessment Tool (“TSAT”)). At S430, model validation may compare measurements to default model response. If the response matches the measurements, the framework may end (e.g., the existing model is sufficiently correct and does not need to be updated). At S440, an event analysis algorithm may determine if event is qualitatively different from previous events. At S450, a parameter identifiability analysis algorithm may determine most identifiable set of parameters across all events of interest. Finally, at S460 an Unscented Kalman Filter (“UKF”)/optimization-based parameter estimation process may be performed. As a result, the estimated parameter values, confidence metrics, and error in model response (as compared to measurements) may be reported.

Events are where the voltage and/or the frequency of the power system changes. For each event, the event screening component determines whether the event is novel enough. For example, an event may be a generator turning on. If the event has the same or similar attributes to a previous event, such as that same generator turning on, then the event screening component skips this event. In the exemplary embodiment, the event screening component compares the event to those events stored in a database. If the event is novel enough, then the event is stored in the database. Then the event is sent to the parameter identifiability component. This component analyzes the event in combination with past events and the parameters identified as significant with those events to determine which parameters ae significant for this event. Then the tunable parameters are transmitted to the Bayesian Optimization component, which further analyzes the significant parameters to calibrate the parameters in the model being executed by the simulation engine.

Disturbance data may be monitored by one or more PMUs coupled to an electrical power distribution grid may be received. The disturbance data can include voltage (“V”), frequency (“f”), and/or active and nonactive reactive (“P” and “Q”) power measurements from one or more points of interest (POI) on the electrical power grid. A power system model may include model parameters. These model parameters can be the current parameters incorporated in the power system model. The current parameters can be stored in a model parameter record. Model calibration involves identifying a subset of parameters that can be “tuned” and modifying/adjusting the parameters such that the power system model behaves identically or almost identically to the actual power component being represented by the power system model.

In accordance with some embodiments, the model calibration can implement model calibration with three functionalities. The first functionality is an event screening tool to select characteristics of a disturbance event from a library of recorded event data. This functionality can simulate the power system responses when the power system is subjected to different disturbances. The second functionality is a parameter identifiability study. When implementing this functionality, the can simulate the response(s) of a power system model. The third functionality is simultaneous tuning of models using event data to adjust the identified model parameters. According to various embodiments, the second functionality (parameter identifiability) and the third functionality (tuning of model parameters) may be done using a surrogate model in place of a dynamic simulation engine.

Instead of using the time consuming simulation engine, the surrogate model or models (such as Neural Networks) with equivalent function of dynamic simulation engine, may be used for both identifiability and calibration. The surrogate model may be built offline while there is no request for model calibration. Once built, the surrogate model comprising a set of weights and bias in learned structure of network will be used to predict the active power (\hat{P}) and reactive (\hat{Q}) given different set of parameters together with time stamped voltage (V) and frequency (f).

The parameter identifiability analysis addresses two aspects: (a) magnitude of sensitivity of output to parameter change; and (b) dependencies among different parameter sensitivities. For example, if the sensitivity magnitude of a particular parameter is low, the parameter would appear in a row being close to zero in the parameter estimation problem's Jacobian matrix. Also, if some of the parameter sensitivities have dependencies, it reflects that there is a linear dependence among the corresponding rows of the Jacobian. Both these scenarios lead to singularity of the Jacobian matrix, making the estimation problem infeasible. Therefore, it may be important to select a subset of parameters which are highly sensitive as well as result in no dependencies among parameter sensitivities. Once the subset of parameters is identified, values in the active power system model for the parameters may be updated, and the system may generate a report and/or display of the estimated parameter values(s), confidence metrics, and the model error response as compared to measured data.

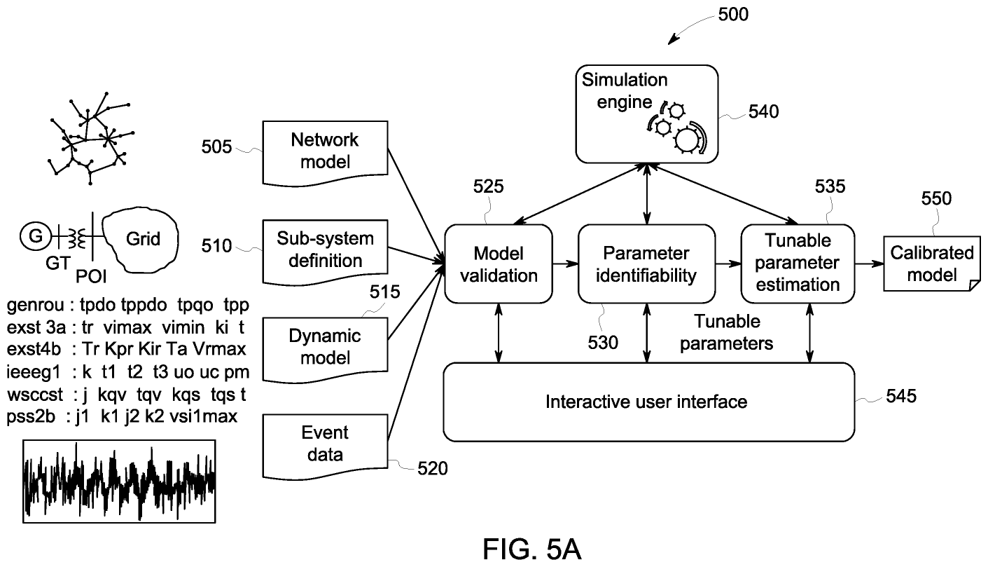

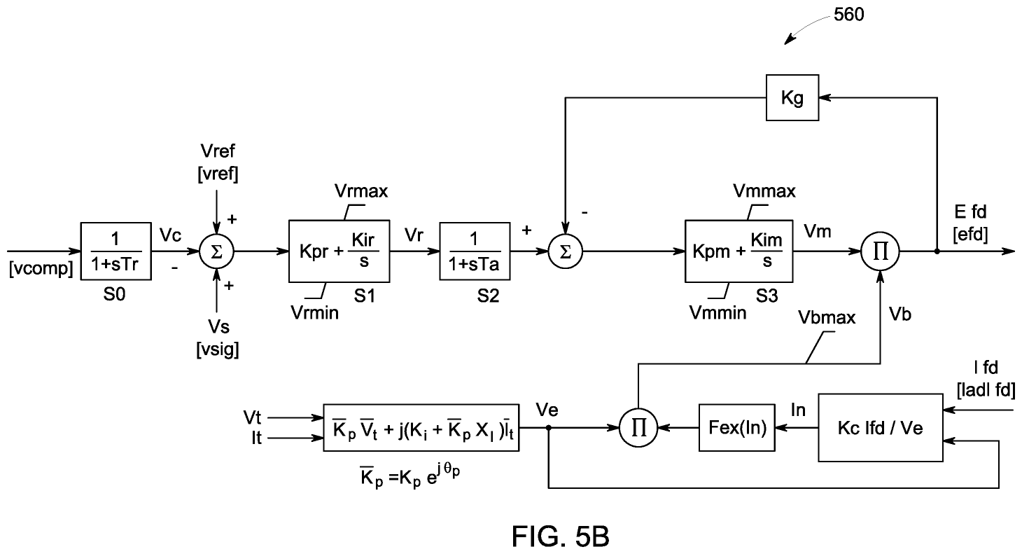

FIG. 5A illustrates a block diagram of an exemplary system architecture 500 for interactive power system model calibration, in accordance with one embodiment of the disclosure. In the exemplary embodiment, the system architecture 500 receives network models 505, sub-system definitions 510, dynamic models 515, and event data 520.

In the exemplary embodiment disclosed herein, the model utilizes multiple disturbance events to validate and calibrate power system models for compliance with NERC mandated grid reliability requirements. The interactive model calibration system described herein comprises three steps. The first step is an interactive user console to allow a user to select a local region for emphasis or de-emphasis. The next step is a parameter identifiability module configured to analyze the mutual information between the measurement value and the Jacobian matrix. The third step in an integrated approach where the parameter identifiability module and the nonlinear least square optimization for parameter estimation automatically assigns the weights based on the user's selection on the user console.

Steady state network models 505 (sometimes called as power-flow data) can be either EMS or system planning models. In some embodiments, they may be in e-terra NETMOM or CIM13 format. Dynamic models 515 can be in either PSS/E or PSLF or TSAT format. The system 500 can also accept more than one dynamic data file when data is distributed among multiple files. In the exemplary embodiment, the network model 505 and the dynamic model 515 use the same naming convention for the network elements.

In the exemplary embodiment, the sub-system definitions 510 are based on the network model 505 and one or more maps of the power plant. A sub-system identification module combines the network model 505 and the one or more maps to generate the sub-system definition 510. In some embodiments, the sub-system definition 510 is provided via an XML file that defines the POI(s) and generators that makes up a power plant. Power plants are defined by generators in the plant with its corresponding POI(s). A few examples of power plant sub-system definitions are listed below in TABLE 1.

In the exemplary embodiment, the system 500 provides a user interface to facilitate defining the power plant starting from a potential POI. Potential POIs are identified as terminals/buses in the system having all required measurements (V, f, P, Q) to perform model validation and calibration. A measurement mapping module identifies terminals with V, f, P, Q measurements and lets the user search for radially connected generators starting from potential POIs. Sub-system definitions 510 may also be saved for future use.

Events are where the voltage and/or the frequency of the power system changes. For example, an event may be a generator turning on. In some embodiments, the event has the same or similar attributes to a previous event, such as that same generator turning on, the event is skipped to reduce redundant processing. In the exemplary embodiment, the event data or Phasor data 520 will be imported from a variety of sources, such as, but not limited to, e-terraphasorpoint, openPDC, CSV files, COMTRADE files and PI historian. In the exemplary embodiment, the POIs will have at least voltage, frequency, real power and reactive power measurements. In some embodiments, voltage angle is substituted for frequency.

The network models 505, sub-system definitions 510, dynamic models 515, and event data 520 are analyzed and validated by the model validation component 525. If the models are validated, then the corresponding data is sent to a parameter identifiability component 530. This component 530 analyzes the event and models to determine which parameters are significant for this event. Then the tunable parameters are transmitted to a tunable parameter estimation component 535, which further analyzes the significant parameters to calibrate the parameters in the model being executed by the simulation engine 540. In the exemplary embodiment, the model validation component 525, the parameter identifiability component 530, and the tunable parameter estimation component 535 are all in communication with an interactive user interface 545, which allows the user to fine tune the model calibration and add subject matter expert knowledge to the model calibration process. The end result is a fully calibrated model 550. The steps in this process are further described below.

In the exemplary embodiment, the model validation component 525 validates the models 505 and 515 and definitions 510 that are being input into the system 500. In at least one embodiment, a typical synchronous generator model has four parts: machine model, turbine-governor model, excitation model and power system stabilizer (PSS) model. The model validation component 525 validates the provided models based on a collection of published NERC List of Acceptable Models, user preferences, and historical data. In some embodiments, there may also be prohibited model lists that are evaluated. Furthermore, units with a power system stabilizer (PSS) should have an excitation system model.

In the exemplary embodiment, the user will be notified if any prohibited model or missing excitation model has been identified. Based on this information, the user can further correct the dynamic model 515 if there is human error, or to use the model conversion module to convert any prohibited model to the valid models before evaluating the curve fitting performance. Of course, the user can also ignore the warning and continue the model validation and calibration process.

The second step is the parameter identifiability. The goal of this step is to perform a comprehensive identifiability study across the models 505 and 515, the definitions 510, and the events 520 and provide an identifiable parameter set for the simultaneous calibration which tunes the most identifiable parameters. The parameter identifiability component 530 analyzes the parameters to identify potential parameters for use based on the dot product (or scalar product) of the columns of J and r as defined below. In the exemplary embodiment, r is called residual which is the difference between the measured response data series and the simulated response data series where:

r(p)=yₜ^{m}−yₜ(x) EQ. 1

where yₜ^{m} is the measured response of active and reactive power provided in the event data 520, yₜ(x) is the simulated response of active and reactive power based on dynamic simulation engine, including but not limited to, GE's PSLF, Siemens PTI's PSS/E, etc. x represents the model parameters. The table below shows one example of parameters for IEEE type ST4B excitation system model.

TABLE 2

| Model | Par | | PSLF |
|---|---|---|---|
| Name | Name | Par Description | Default |
| exst4b | Tr | Filter time constant, sec | 0.02 |
| exst4b | Kpr | Proportional Gain, pu | 3.15 |
| exst4b | Kir | Integral Gain, pu | 3.15 |
| exst4b | Ta | Time constant, sec | 0.01 |
| exst4b | Vrmax | Maximum control element output, pu | 1 |
| exst4b | Vrmin | Minimum control element output, pu | −0.87 |
| exst4b | Kpm | Prop. Gain of field voltage regulator, pu | 1 |
| exst4b | Kim | Integral Gain of field voltage regulator, pu | 0 |
| exst4b | Vmmax | Maximum field voltage regulator output, pu | 1 |
| exst4b | Vmmin | Minimum field voltage regulator output, pu | −0.87 |
| exst4b | Kg | Excitation limiter gain, pu | 0 |
| exst4b | Kp | Potential source gain, pu | 6.5 |
| exst4b | Angp | Phase angle of potential source, degree | 0 |
| exst4b | Ki | Current source gain, pu | 0 |
| exst4b | Kc | Exciter regulation factor, pu | 0.08 |
| exst4b | Xl | P-bar leakage reactance, pu | 0 |
| exst4b | Vbmax | Maximum excitation voltage | 8 |

FIG. 5B illustrates an exemplary block diagram of the dynamic model 560 relationship using the system 500 (shown in FIG. 5A). The exemplary dynamic model 560 includes the model parameters described in TABLE 2 and how they interact within the model 560 itself

In FIG. 5A, the parameter identifiability component 530 uses the sum of squares (SOS) objective: ∥r(x)∥₂². Then the parameter identifiability component 530 uses the Quadratic Model (QM) of the objective at (xₖ+d) to approximate the next step like r(xₖ₊₁).

QM(Jₖ,rₖ,d)=∥r(x)+Jₖd∥₂² EQ. 2

where Jk is the Jacobian vector, which is equal to

$${J}_{k} = \frac{dr}{dx} {\vert}_{xk} ,$$

and rₖ=r(xₖ) which is the sensitivity result. This leads to:

r(xₖ₊₁)=r(xₖ)+Jₖ(xₖ+d) EQ. 3

The ultimate goal is to get r(xₖ₊₁)=0. This leads to r(xₖ)=Jₖ(xₖ+d).

In the exemplary embodiment, the vector r(xₖ) is compared to the Jacobian vector Jₖ to determine the θ (angle) between them. In some embodiments, each vector Jₖ may have up to 1000 values each, where the number of values in the Jacobian vector depends on the number of sampling points in the event. The θ is calculated by generating the dot product of the vector r(xₖ) to the Jacobian vector Jₖ.

r(xₖ)*Jₖ=∥r(xₖ)∥∥Jₖ∥cosθ EQ. 4

The resulting θ is compared to a threshold. Parameters with a corresponding θ below the threshold are sent to the pool of parameters that are selected. The ideal θ is zero, but that is generally unachievable. In some embodiments, any parameter with a θ of less than 5° is selected by the parameter identifiability component 530. This threshold is configurable by the user, such as through the interactive user interface 545. The key idea is that the more orthogonal the angles are between the vectors of J and r, the less likely changes to that parameter moves the response in the desired way. This approach can be extended to a weighted version, by scaling both the measured response and simulated response with a weight vector wₜ. The weight factor wₜ has the same length of the data samples in the event of interest. In this way, given a defined weight factor, it can affect the above calculated angles are between the vectors of J and r.

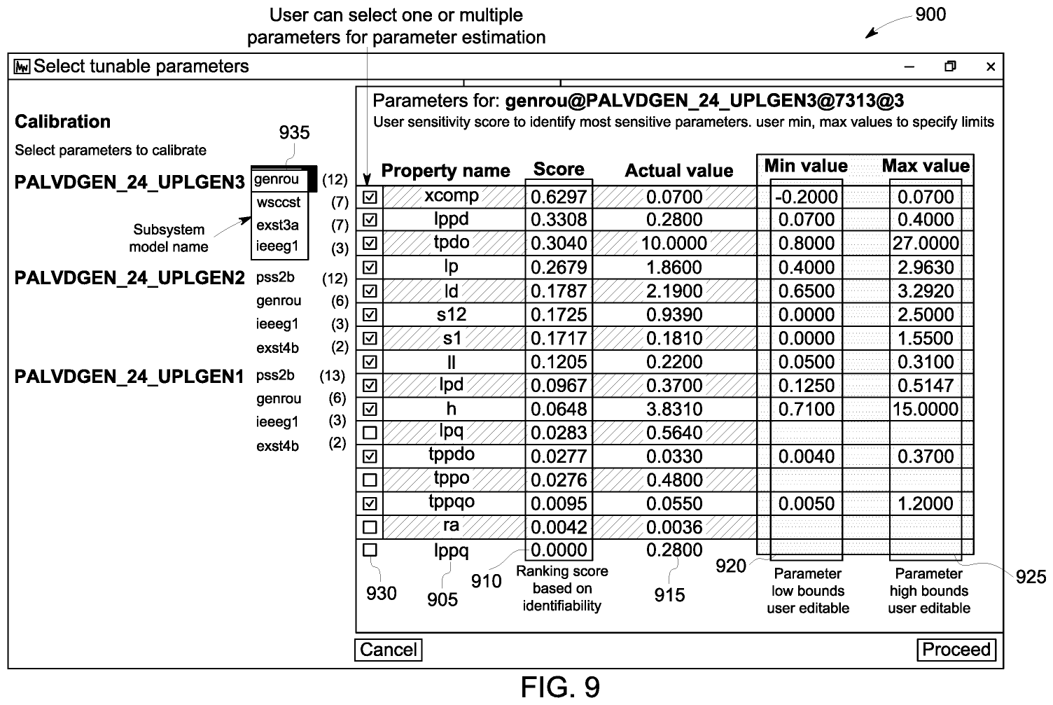

In the exemplary embodiment, the parameter identifiability component 530 receives a plurality of raw parameters x. The parameter identifiability component 530 analyses each of the parameters using the above equations to determine the θ between the Jₖ and the r(xₖ) for each of the parameters. If the θ meets or is below a predetermined threshold, the parameter identifiability component 530 stores that parameter in a pool of parameters. In the exemplary embodiment, the parameter identifiability component 530 presents the parameters in the pool to the user for approval or adjustment via the interactive user interface 545, such as shown in FIG. 9.

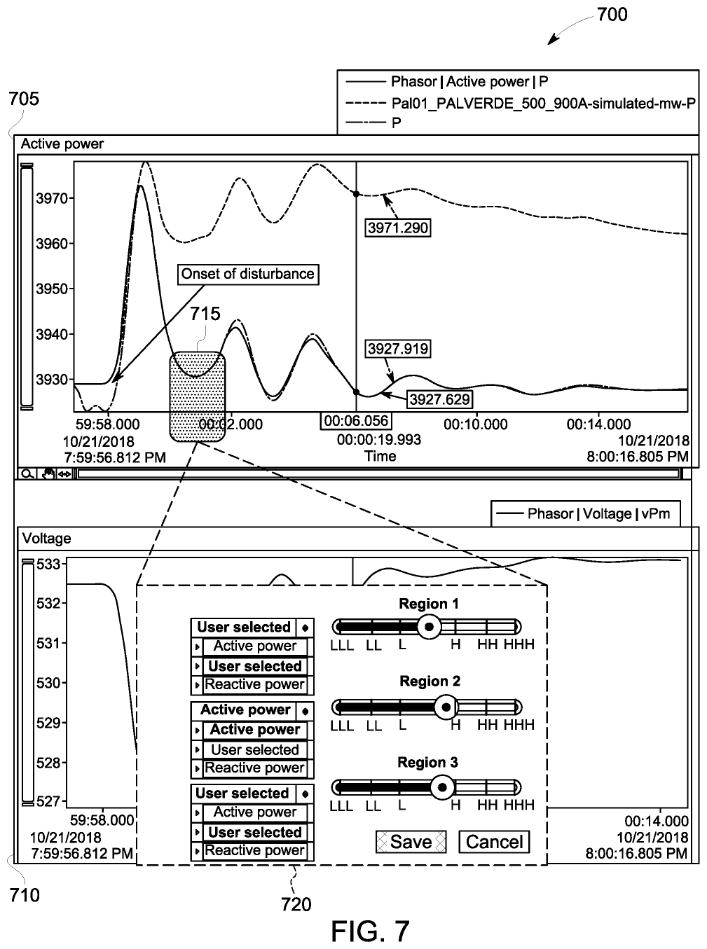

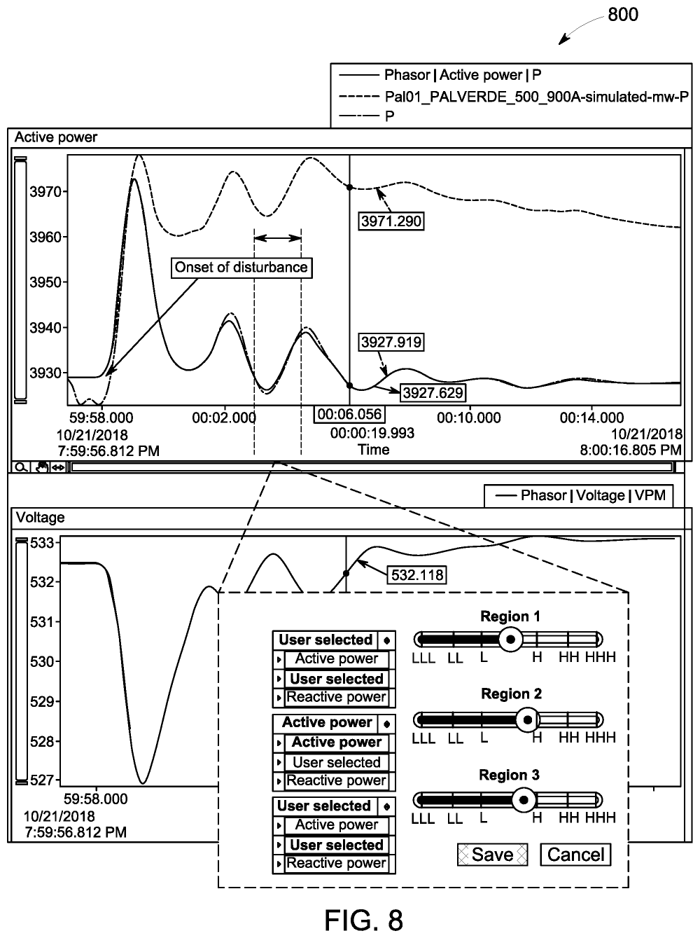

Once selected or confirmed by the user, the tunable parameters are provided to the tunable parameter estimation component 535. The tunable parameter estimation component 535 adjusts the models based on the tunable parameters selected or confirmed by the user. The parameter estimation component 535 also performs weighted non-linear least squares optimizations for estimating the parameters. The goal is to identify the right parameter to minimize the difference between the yₜ(x) and yₜ^{m} so that the estimation matches the measured response.

$${min}_{{x}_{1} \leq x \leq {x}_{u}} {\sum }_{t = 1}^{T} {w}_{t} * {( \frac{{y}_{t}^{m} - {y}_{t} ( x )}{{y}_{base}} )}^{2} \qquad EQ . 5$$

where t represents each point of time in the event, where T is the event time limit, and where wₜ is a weight assigned by the user or the system. In the exemplary embodiment, the interactive user interface 545 allows the user to define regions, which are portions (or time slices) of the event. The user may then assign different weights to each region. For example, a user may assign a first weight for times θ to 0.3 seconds in the event and a second weight for times 0.3 to 1 second into the event. In addition, the user may define two weights for the active power curve and the reactive power curve. In some embodiments, the system defines a default weight that is used for sections or regions that do not have user defined weights. Example user interfaces for defining regions and weights may be found in FIGS. 7 and 8.

In the exemplary embodiment, the parameter estimation component 535 performs multiple iterations of the calculations until the residual error between the measure values and the estimated values is reduced to below a threshold.

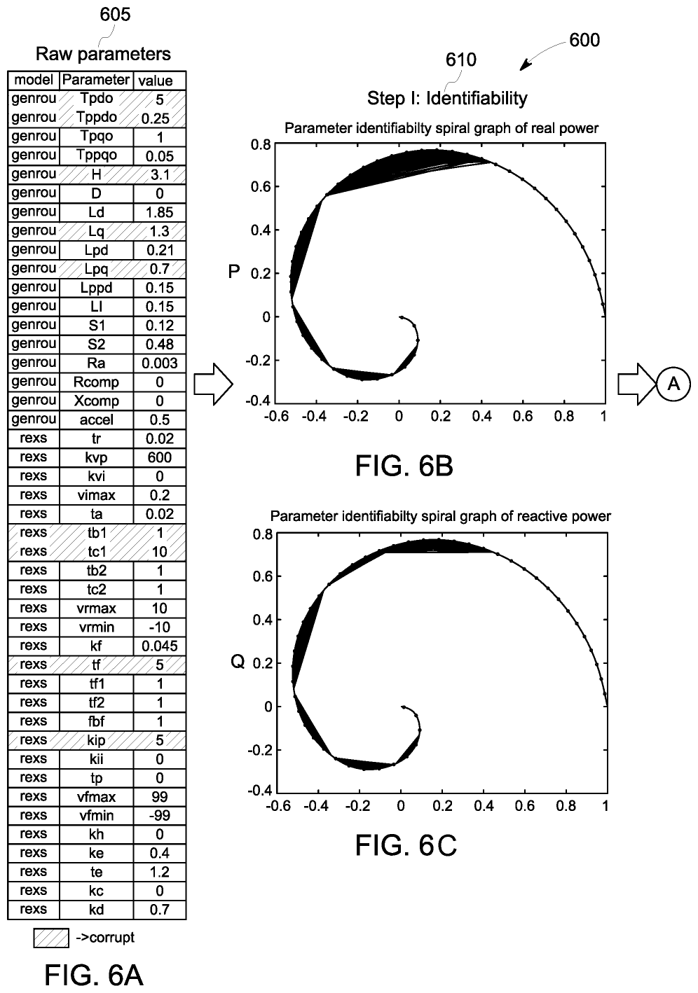

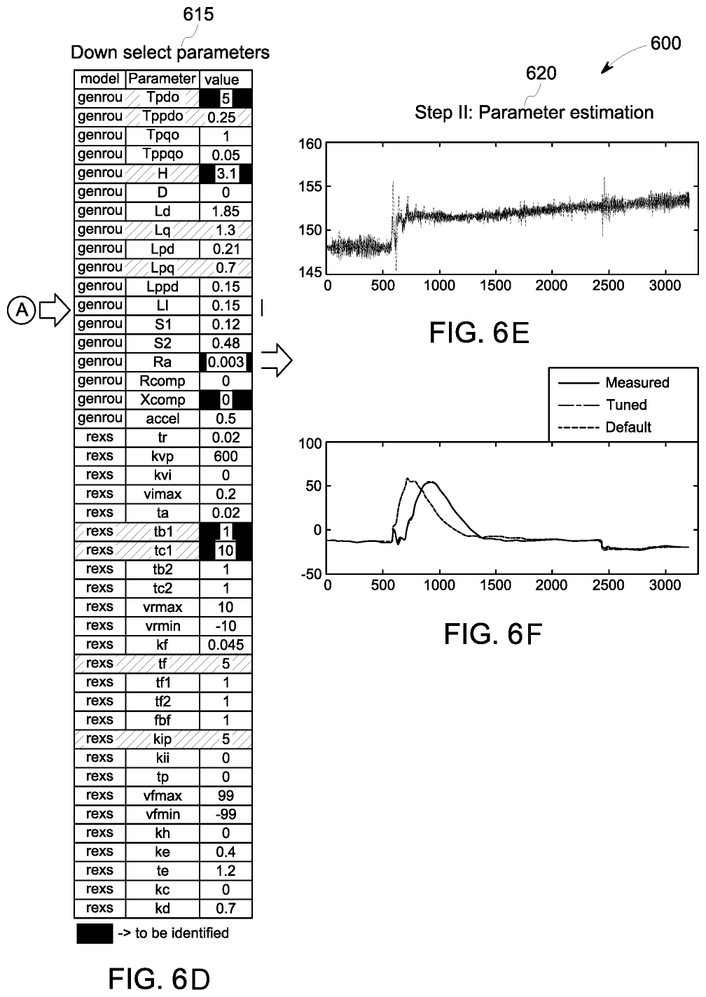

FIGS. 6A-6F illustrate a process 600 for identifying and estimating parameters in accordance with at least one embodiment. In process 600, the raw parameters 605 (shown in FIG. 6A) are analyzed to be identified 610 (shown in FIGS. 6B and 6C). Some of the parameters are then down selected 615 (shown in FIG. 6D). In the exemplary embodiment, these are parameters that have been selected 615 by the system 500 (shown in FIG. 5A). In the exemplary embodiment, these selected parameters are presented to the user, such as through the interactive user interface 545 (shown in FIG. 5A). The user may confirm these parameters, change them, adjust them, and/or override them. Once the user has chosen which parameters are to be evaluated, the system 500 performs parameter estimation 620 (shown in FIGS. 6E and 6F).

FIG. 7 is an exemplary user interface 700 for selecting a local region for calibration in accordance with at least one embodiment. In the exemplary embodiment, user interface 700 is provided by interactive user interface 545 (shown in FIG. 5A). In the exemplary embodiment, user interface 700 displays active power 705 and voltage 710 for an event, showing actual and estimated curves. The user interface 700 allows the user to select a region 715 of one of the curves. In this embodiment, the user interface may select a portion of the curve by selecting two points to create a box that outlines the region 715. When the region is selected, the user interface 700 displays a weighting interface 720. The weighting interface 720 includes a plurality of weighting sliding bars 725 for a plurality of regions. Each of the plurality of weighting sliding bars 725 includes a plurality of weights that the user may set with the slider.

In the exemplary embodiment, the user may set the weights for each selected region, the entire active power curve, and the entire reactive power curve. While only three weighting sliding bars 725 are shown, any number of regions may be selected and weighted. For example, a user may select a region at the beginning of the curve, where the curves are significantly different. The user may then weight that region highly. Then the user may select the region after the vertical line, where the curves are closer to a steady state and then give that region a very low rate.

When a region 715 is selected, the region 715 includes all of the points in time included in that region 715. These points in time are used with their corresponding weights in the parameter estimation component 535 as described above.

As shown in this embodiment, the weights are relative based on the plurality of weighting sliding bars 725. In other embodiments, the user may enter the actual weights or provide them in any other methodology that allows the system to perform as described herein.

In the exemplary embodiment, the user interface 700 allows the user to use the cursor to select a region 715 of event data where user may exert higher or lower emphasize on that region 715. Once the user selects the region 715, the weighting interface 720 pops up to allow user to further configure the selections. The weighting interface 720 has two parts. The left side specifies the user selected variable or region, it can be active power, reactive power, or user selected region. When user selects region 1, the right side provides weighting sliding bars 725 with 7 levels of significance that user can use. LLL means Low Low Low, and HHH means High High High. By default, all region are at normal (bar at the middle). If the Active power is selected, that means the user puts more/less emphasis on the whole active power curve. Once complete, user select saves to save the changes. In the exemplary embodiment, there is a default weight associated with each bar location. For example, when the sliding bar is located at the middle, the weight for selected region can be set as all ones, which means no emphasis or de-emphasis should be exerted for this region. However, if the sliding bar is located at the “H” position, the weight for selected region may set as 2, which means the residual of the selected region weighs twice than the rest of regions. In another example, the sliding bar is located at the “H” position. In this example, the weight for selected region may be set as ½, which means the residual of the selected region weighs half of the rest of regions. An example of automatic weight settings is given in the table below.

TABLE 3

| Bar location | Weight |
|---|---|
| LLL | 1/10 |
| LL | ⅕ |
| L | ½ |
| Middle | 1 |
| H | 2 |
| HH | 5 |
| HHH | 10 |

In some embodiments, there could be multiple variations to be used in practice based on above table. For example, the TABLE 4 shown below illustrates an embodiment wherein only one side (the High side) is used for weighting purpose. This means those selected regions can be only emphasized with weights higher than 1. This is especially useful when the user wants to highlight a region which is more important, and takes more attention than other regions. Those regions could represent more dynamic information during the whole event.

TABLE 4

| Bar location | Weight |
|---|---|
| Middle | 1 |
| H | 2 |
| HH | 5 |
| HHH | 10 |

TABLE 5 below illustrates another preferred embodiment for weighting. It is same as the above table except that it has only two high levels H and HH, representing 2× and 5× respectively. The advantage for this embodiment is its simplicity. The disadvantage for this embodiment is that it provides less options.

TABLE 5

| Bar location | Weight |
|---|---|
| Middle | 1 |
| H | 2 |
| HH | 5 |

FIG. 8 is another exemplary user interface 800 for selecting a local region for calibration in accordance with at least one embodiment. In the exemplary embodiment, user interface 800 is provided by interactive user interface 545 (shown in FIG. 5A). Every element of user interface 800 is similar to user interface 700 (shown in FIG. 7), except instead of selecting the regions using a box mechanism as shown in FIG. 7, the user interface 800 in FIG. 8 illustrates the use of two or more vertical sliding bars to define the beginning and the end of each region. By simply moving around the vertical line, the user can define the region between the adjacent lines as the highlighted region.

FIG. 9 is an exemplary user interface 900 for identifying parameters for calibration in accordance with at least one embodiment. In the exemplary embodiment, user interface 900 is provided by interactive user interface 545 (shown in FIG. 5A).

In the exemplary embodiment, the system 500 (shown in FIG. 5A) provides a plurality of selected parameters 905 for the user to confirm and/or adjust. In the exemplary embodiment, these parameters 905 were selected in step 615 of process 600. In the exemplary embodiment, these parameters 905 were selected using the parameter identifiability component 530 (shown in FIG. 5A) described above. The user interface 900 also displays the score 910 associated with each parameter 905. The score 910 represents the identifiability and sensitivity of each parameter 905. In some embodiments, the score 910 is based on the θ angle calculated above and potentially the threshold, such as the difference between or a normalized percentage. In the exemplary embodiment, the user interface 900 also displays actual values 915, minimum values 920 and maximum values 925 for each of the parameters 905. In some embodiments, the minimum values 920 and the maximum values 925 are editable by the user.

In the exemplary embodiment, the user interface 900 also displays a selection box 930 for each of the parameters 905. The user may activate the selection box 930 to determine whether or not the corresponding parameter 905 will be used.

The user interface also displays one or more selection boxes 935 for the user to select which generator or device that is being modeled. For example, “genrou” as shown in the figure represents a solid rotor generator model. In this example, the parameters 905 shown in the user interface 900 are parameters associated with the Genrou model. Other models include, but are not limited to, Wsccst—WSCC Power System Stabilizer model; Exst3a—Modified IEEE (1980) type ST3 excitation system model; and Ieeeg1—IEEE steam turbine/governor model (with deadband and nonlinear valve gain added).

A typical generator model has at least four sub-models: generator model, turbine-governor model, excitation system model and power system stabilizer models. These sub-models comply with the corresponding IEEE standards. For example, the Genrou model includes a plurality of parameters, a sub-set of which are those shown in the Table below.

TABLE 6

| Parameter Name | Parameter Description |
|---|---|
| Tpdo | D-axis transient rotor time constant |
| Tppdo | D-axis sub-transient rotor time constant |
| Tpqo | Q-axis transient rotor time constant |
| Tppqo | Q-axis sub-transient rotor time constant |
| H | Inertia constant, sec |
| D | Damping factor, pu |
| Ld | D-axis synchronous reactance |
| Lq | Q-axis synchronous reactance |
| Lpd | D-axis transient reactance |
| Lpq | Q-axis transient reactance |
| Lppd | D-axis sub-transient reactance |
| Ll | Stator leakage reactance, pu |
| S1 | Saturation factor at 1 pu flux |
| S12 | Saturation factor at 1.2 pu flux |
| Ra | Stator resistance, pu |
| Rcomp | Compounding resistance for voltage control, pu |
| Xcomp | Compounding reactance for voltage control, pu |

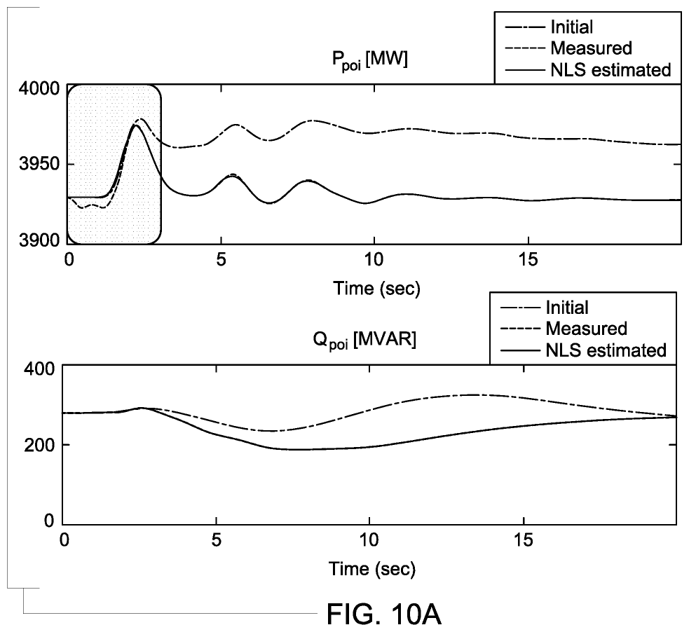

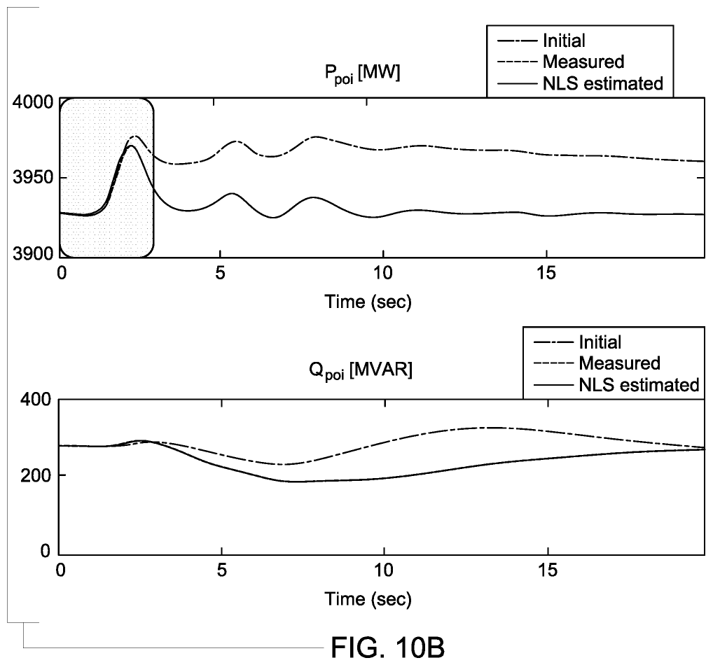

FIGS. 10A and 10B illustrate exemplary graphs of active and reactive power before and after calibration using the system 500 (shown in FIG. 5A). FIG. 10A illustrates the active and reactive power curves for an event prior to calibration. FIG. 10B illustrates the active and reactive power curves for the same event after the parameters have been identified and tuned and the system 500 has performed the calculations described above. At the beginning of each of the active power curves is a defined region. In the region in FIG. 10A, there is a noticeable difference between the measured and estimated curves. In FIG. 10B, this difference has been rectified using the systems and methods described herein.

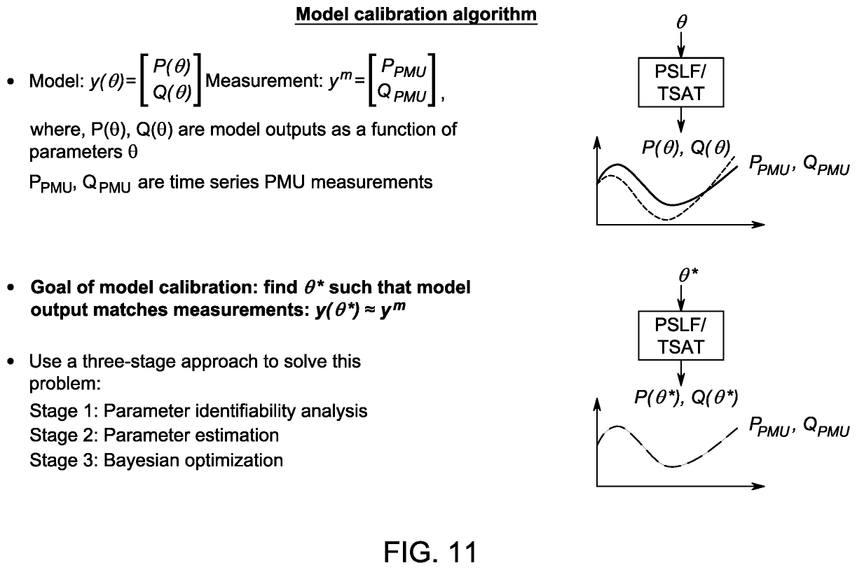

FIG. 11 illustrates a model calibration algorithm that can be used by the model calibration algorithm component in accordance with some embodiments. Here, the model calibration algorithm attempts to find a parameter value (θ*) for a parameter (or parameters) of the power system model that creates a matching output between the simulated active power (\hat{P}) and the simulated reactive power (\hat{Q}) predicted by the model with respect to the actual active power (P) and actual reactive power (Q) of the component on the electrical grid.

As grid disturbances occur intermittently, the user of the calibration tool described herein may be required to re-calibrate model parameters in a sequential manner as new disturbances come in. In this scenario, the user has a model that was calibrated to some observed grid disturbances to start with, and observes a larger that acceptable mismatch with a newly encountered disturbance. The task now is to tweak the model parameters so that the model explains the new disturbance without detrimentally affecting the match with earlier disturbances. One solution would be to run calibration simultaneously on all events of interest strung together but this comes at the cost of significant computational expense and engineering involved in enabling running a batch of events simultaneously. It would be far more preferable to carry some essential information from the earlier calibrations runs and guide the subsequent calibration run that helps explain the new disturbance without losing earlier calibration matches.

In the exemplary embodiment, the framework of Bayesian estimation may be used to develop a sequential estimation capability into the existing calibration framework. The true posterior distribution of parameters (assuming Gaussian priors) after the calibration process can be quite complicated due to the nonlinearity of the models. The typical approach in sequential estimation is to consider a Gaussian approximation of this posterior as is done in Kalman filtering approaches to sequential nonlinear estimation. In a nonlinear least squares approach, this boils down to a quadratic penalty term for deviations from the previous estimates, and the weights for this quadratic penalty come from a Bayesian argument.

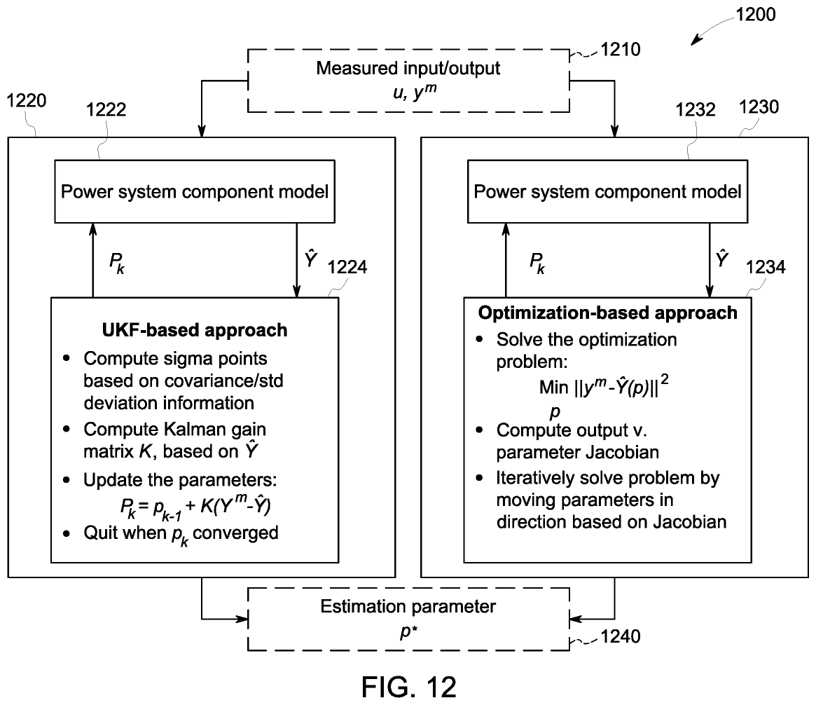

FIG. 12 illustrates candidate parameter estimation algorithms 1200 according to some embodiments. In one approach 1220, measured input/output data 1210 (u, y^{m}) may be used by a power system component model 1222 and an UKF based approach 1224 to create an estimation parameter (p*) 1240.

In particular, the system may compute sigma points based on covariance and standard deviation information. The Kalman Gain matrix K may be computed based on Ŷ and the parameters may be updated based on:

pₖ=pₖ₋₁+K(y^{m}−ŷ) EQ. 6

until pₖ converges. According to another approach 1230, the measured input/output data 1210 (u, y^{m}) may be used by a power system component model 1232 and an optimization-based approach 1234 to create the estimation parameter (p*) 1240. In this case, the following optimization problem may be solved:

minₚ∥y^{m}−Ŷ(p)∥² EQ. 7

The system may then compute output as compared to parameter Jacobian information and iteratively solve the above optimization problem by moving parameters in directions indicated by the Jacobian information.

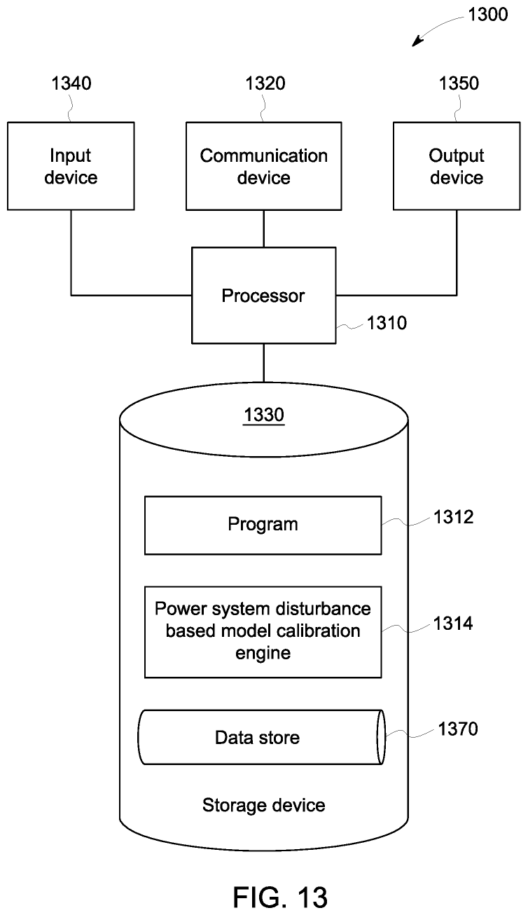

The embodiments described herein may also be implemented using any number of different hardware configurations. For example, FIG. 13 is a block diagram of an apparatus or platform 1300 that may be, for example, associated with the system 200 of FIG. 2 and/or any other system described herein. The platform 1300 comprises a processor 1310, such as one or more commercially available Central Processing Units (“CPUs”) in the form of one-chip microprocessors, coupled to a communication device 1360 configured to communicate via a communication network (not shown in FIG. 13). The communication device 1360 may be used to communicate, for example, with one or more remote measurement units, components, user interfaces, etc. The platform 1300 further includes an input device 1340 (e.g., a computer mouse and/or keyboard to input power grid and/or modeling information) and/an output device 1350 (e.g., a computer monitor to render a display, provide alerts, transmit recommendations, and/or create reports). According to some embodiments, a mobile device, monitoring physical system, and/or PC may be used to exchange information with the platform 1300.

The processor 1310 also communicates with a storage device 1330. The storage device 1330 may comprise any appropriate information storage device, including combinations of magnetic storage devices (e.g., a hard disk drive), optical storage devices, mobile telephones, and/or semiconductor memory devices. The storage device 1330 stores a program 1312 and/or a power system disturbance based model calibration engine 1314 for controlling the processor 1310. The processor 1310 performs instructions of the programs 1312, 1314, and thereby operates in accordance with any of the embodiments described herein. For example, the processor 1310 may calibrate a dynamic simulation engine, having system parameters, associated with a component of an electrical power system (e.g., a generator, wind turbine, etc.). The processor 1310 may receive, from a measurement data store 1370, measurement data measured by an electrical power system measurement unit (e.g., a phasor measurement unit, digital fault recorder, or other means of measuring frequency, voltage, current, or power phasors). The processor 1310 may then pre-condition the measurement data and set-up an optimization problem based on a result of the pre-conditioning. The system parameters of the dynamic simulation engine may be determined by solving the optimization problem with an iterative method until at least one convergence criteria is met. According to some embodiments, solving the optimization problem includes a Jacobian approximation that does not call the dynamic simulation engine if an improvement of residual meets a pre-defined criteria.

The programs 1312, 1314 may be stored in a compressed, uncompiled and/or encrypted format. The programs 1312, 1314 may furthermore include other program elements, such as an operating system, clipboard application, a database management system, and/or device drivers used by the processor 1310 to interface with peripheral devices.

As used herein, information may be “received” by or “transmitted” to, for example: (i) the platform 1300 from another device; or (ii) a software application or module within the platform 1300 from another software application, module, or any other source.

At least one of the technical solutions to the technical problems provided by this system may include: (i) improved speed in modeling parameters; (ii) more robust models in response to measurement noise; (iii) compliance with NERC mandated grid reliability requirements; (iv) allowing the user to influence the calibration of the model in real-time; and (v) reducing the require computation resources required by reducing the number of parameters analyzed.

The methods and systems described herein may be implemented using computer programming or engineering techniques including computer software, firmware, hardware, or any combination or subset thereof, wherein the technical effects may be achieved by performing at least one of the following steps: (a) receiving event data and model response data associated with a model to simulate; (b) identifying a plurality of tunable parameters based on the event data and the model response data; (c) presenting, via a user interface, the plurality of tunable parameters to the user; (d) receiving, from the user via the user interface, one or more selections of the plurality of tunable parameters; (e) presenting, to the user via the user interface, a view of an event, including a measured curve and an estimated curve; (f) receiving, from the user via the user interface, a selection of a first region of the event; (g) receiving, from the user via the user interface, a first weight associated with the first region; (h) performing a plurality of simulations on the model including the first weight and the one or more selections; and (i) calibrating the model based on the plurality of simulations.

The computer-implemented methods discussed herein may include additional, less, or alternate actions, including those discussed elsewhere herein. The methods may be implemented via one or more local or remote processors, transceivers, servers, and/or sensors, and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may employ artificial intelligence and/or be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as image data, text data, report data, and/or numerical analysis. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract data about the computer device, the user of the computer device, the computer network hosting the computer device, services executing on the computer device, and/or other data.

Based upon these analyses, the processing element may learn how to identify characteristics and patterns that may then be applied to training models, analyzing sensor data, and detecting abnormalities.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another embodiment, a computer program is provided, and the program is embodied on a computer-readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, Calif.). In yet a further embodiment, the system is run on a Mac OS® environment (Mac OS is a registered trademark of Apple Inc. located in Cupertino, Calif.). In still yet a further embodiment, the system is run on Android® OS (Android is a registered trademark of Google, Inc. of Mountain View, Calif.). In another embodiment, the system is run on Linux® OS (Linux is a registered trademark of Linus Torvalds of Boston, Mass.). The application is flexible and designed to run in various different environments without compromising any major functionality.

In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

As used herein, an element or step recited in the singular and preceded by the word “a” or “an” should be understood as not excluding plural elements or steps, unless such exclusion is explicitly recited. Furthermore, references to “example embodiment,” “exemplary embodiment,” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system for interactive power system model calibration comprising a computing device including at least one processor in communication with at least one memory device, wherein the at least one processor is programmed to:
receive event data and model response data associated with a model to simulate;
identify a plurality of tunable parameters based on the event data and the model response data;
present, via a user interface, the plurality of tunable parameters to the user;
receive, from the user via the user interface, one or more selections of the plurality of tunable parameters; and
calibrate the model based on the one or more selections.

2. The system in accordance with claim 1, wherein the one or more selections include a sub-set of the plurality of tunable parameters, and wherein the at least one processor is further programmed to use the sub-set of the plurality of tunable parameters while calibrating the model.

3. The system in accordance with claim 1, wherein the one or more selections include one or more adjustments to one or more parameters of the plurality of tunable parameters, and wherein the at least one processor is further programmed to use the one or more adjustments to one or more parameters while calibrating the model.

4. The system in accordance with claim 1, wherein the model includes a plurality of parameters, and wherein the at least one processor is further programmed to identify the plurality of tunable parameters based on a difference between the event data and model response data with estimated model parameters.

5. The system in accordance with claim 4, wherein the at least one processor is further programmed to generate a score for each of the plurality of parameters based on the difference between the event data and model response data with estimated model parameters and a Jacobian matrix corresponding to model response data.

6. The system in accordance with claim 5, wherein the at least one processor is further programmed to generate the score based on a dot product angle between the difference the event data and model response data and components of the Jacobian matrix.

7. The system in accordance with claim 6, wherein the at least one processor is further programmed to select the plurality of tunable parameters based on the dot product angle not exceeding a threshold.

8. The system in accordance with claim 1, wherein the at least one processor is further programmed to:
present, to the user via the user interface, a view of an event, including a measured curve and an estimated curve;
receive, from the user via the user interface, a selection of a first region of the event;
receive, from the user via the user interface, a first weight associated with the first region; and
perform a plurality of simulations on the model including the first weight.

9. The system in accordance with claim 8, wherein the first region includes a plurality of points in time and wherein the first weight is associated with the plurality of points in time.

10. The system in accordance with claim 9, wherein the user interface is configured to:
receive a selection of two points on the view; and
generate the first region based on those two points.

11. The system in accordance with claim 9, wherein the user interface is configured to:
display two vertical lines on the view;
receive user selected positions for the two vertical lines; and
generate the first region based on user selected positions for the two vertical lines.

12. The system in accordance with claim 9, wherein the at least one processor is further programmed to assign a default weight to points in time not associated with the first region.

13. The system in accordance with claim 8, wherein the at least one processor is further configured to:
receive, from the user via the user interface, a selection of a second region of the event;
receive, from the user via the user interface, a second weight associated with the second region; and
perform the plurality of simulations on the model including the first weight and the second weight.

14. The system in accordance with claim 8, wherein the at least one processor is further programmed to receive, from the user via the user interface, a second weight associated with one of an active power curve and a reactive power curve.

15. The system in accordance with claim 1, wherein the at least one processor is further programmed to validate the model.

16. A method for interactive power system model calibration, the method implemented on a computing device including at least one processor in communication with at least one memory device, the method comprises:
receiving event data and model response data associated with a model to simulate;
identifying a plurality of tunable parameters based on the event data and the model response data;
presenting, via a user interface, the plurality of tunable parameters to the user;
receiving, from the user via the user interface, one or more selections of the plurality of tunable parameters;
presenting, to the user via the user interface, a view of an event, including a measured curve and an estimated curve;
receiving, from the user via the user interface, a selection of a first region of the event;
receiving, from the user via the user interface, a first weight associated with the first region;
performing a plurality of simulations on the model including the first weight and the one or more selections; and
calibrating the model based on the plurality of simulations.

17. The method in accordance with claim 16, wherein the one or more selections include at one of a sub-set of the plurality of tunable parameters and one or more adjustments to one or more parameters of the plurality of tunable parameters.

18. The method in accordance with claim 16, wherein the model includes a plurality of parameters, and wherein the method further comprises:
calculating the difference between event data and model response data for the plurality of parameters;
generating a Jacobian matrix for the plurality of parameters; and
identifying the plurality of tunable parameters based on a dot product angle between the difference and the Jacobian matrix where the dot product angle does not exceed a predetermined threshold.

19. The method in accordance with claim 16 further comprising:
receiving, from the user via the user interface, a selection of a second region of the event;
receiving, from the user via the user interface, a second weight associated with the second region; and
performing the plurality of simulations on the model including the first weight and the second weight, wherein the first weight is associated with a first plurality of points in time associated with the first region and the second weight is associated with a second plurality of points in time associated with the second region.

20. The method in accordance with claim 16 further comprising receiving, from the user via the user interface, a second weight associated with one of an active power curve and a reactive power curve.
